(19) United States
(12) Patent Application Publication
(10) Pub. No.: US 2008/0136794 A1
(43) Pub. Date: Jun. 12, 2008

(54) INPUT DEVICES INCORPORATING PIXELS AND PHOTO SENSORS

(75) Inventors: TOMOHIRO ISHIKAWA, EVANSTON, IL (US); ROBERT D. POLAK, LINDENHURST, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/567,929

(22) Filed: Dec. 7, 2006

(51) Int. Cl. G06F 3/042

(52) U.S. Cl. 345/175

(57) ABSTRACT

Disclosed are devices for integrating photo sensors into sub-pixels of pixels of an array of pixels to substantially maintain the brightness of a touch screen display. In one embodiment, one or more photo sensors are distributed across two colored sub-pixels. Accordingly, the aperture ratios of the sub-pixels can be more substantially equal than the aperture ratios of the sub-pixels when a single sub-pixel includes a photo sensor. In another embodiment, one or more photo sensors are distributed across three sub-pixels. Accordingly, the aperture ratios of the sub-pixels may be substantially equal so that the light from each of the colors may mix in substantially equal amounts to generate white light. A white sub-pixel may be included with the sub-pixels of a pixel. A photo sensor may be integrated into the white sub-pixel. White light from combined colored light of sub-pixels can be further brightened by light from the white sub-pixel.

### FIELD

Disclosed are input devices, electronic devices, and methods for touch input, and more particularly, for integrating photo sensors into sub-pixels of pixels of an array of pixels to substantially maintain the brightness of a display with a touch input.

### BACKGROUND

Manufacturers of electronic products often include touch sensitive user interface devices on their products. In one implementation, a touch sensitive screen may receive input to photo sensors that are positioned with or embedded in a sub-pixel of a pixel of an array of pixels forming a display screen. Such a display is said to be a display with a touch input. Input to a photo sensor can be detected in different manners. For example, a change in the size or location of a shadowed area or a bright area as a function of time may indicate that an object such as finger or stylus is nearing or proximal the touch screen.

Touch sensitive user interface devices and displays are widely used in electronic products, such as communication devices, computer monitors and televisions. These devices and displays provide images as a collection of pixels in which each pixel includes sub-pixels. Pixels are picture elements that are units constituting images. Thus, images may be represented by a collection of discrete pixels. Each pixel may be subdivided into multiple sub-pixels having different colors. Each sub-pixel is associated with a color, such as the primary colors red, green and blue or, in the alternative, may include non-primary colors such as white or yellow. Accordingly, color images may be displayed as a collection of pixels having different colors. The color of each individual pixel is controlled by the brightness of its sub-pixels.

Photo sensors are sensors that detect light. Upon receiving light, photo sensors generate signals in which its amplitude depends on the intensity of the light. By forming an array of photo sensors, one can detect images through a mapping of a signal generated by an individual photo sensor.

For a full color display, each pixel of an array of pixels incorporated into the display screen may include at least three sub-pixels. For example, red, green and blue (RGB) sub-pixels may form an RGB pixel. Equal amounts of light from each color can form white light.

There may be several different implementations in positioning a photo sensor proximal a sub-pixel or integrating a photo sensor with a sub-pixel. Typically, photo sensors are mapped to fewer than each pixel, for example, in a one-to-three ratio. A photo sensor is placed in a corner of a pixel partially covering the area of a sub-pixel, typically a red sub-pixel. The aperture ratio characterizes how much light from the pixel or sub-pixel can get through. An aperture ratio can be considered to be the portion of the pixel or sub-pixel that is available to emit light.

By covering a portion of one sub-pixel with a photo sensor element, the aperture ratio of the sub-pixel is reduced, and white light generated by the combination of light of the three sub-pixel RGB configuration is reduced. If the photo sensor reduces the aperture ratio of the red sub-pixel compared to the blue and green sub-pixels, the light from each of the colors do not mix in substantially equal amounts and the generation of white light can be inhibited. Therefore, the brightness of the display can be compromised by the placement of photo sensor elements integrated into one sub-pixel of plurality of pixels of an array of pixels.

### BRIEF DESCRIPTION OF THE DRAWINGS

FIG. 1 depicts an electronic device, for example a mobile communication device, with a display;

FIG. 2 depicts a display screen that can include of an array of pixels;

FIG. 3 illustrates an embodiment of an enlargement of a pixel of FIG. 2 where instead of one photo sensor, there may be two individual photo sensors;

FIG. 4 depicts an embodiment of a pixel including three sub-pixels;

FIG. 5 depicts an embodiment in which three sub-pixels can include three individual integrated photo sensors; and

FIG. 6 depicts a pixel having at least two sub-pixels selected from sub-pixels so that one of the at least two sub-pixels is a white sub-pixel.

### DETAILED DESCRIPTION

Disclosed are input devices, electronic devices and methods for integrating photo sensors into sub-pixels of pixels of an array of pixels to substantially maintain the brightness of a touch screen display. In a full color display, each pixel of an array of pixels incorporated into the display screen can include at least three sub-pixels, for example three sub-pixels can form an RGB pixel. In one disclosed embodiment, one or more photo sensors are distributed across two colored sub-pixels. Accordingly, the aperture ratios of the sub-pixels can be more substantially equal than the aperture ratios of the sub-pixels when a single sub-pixel includes a photo sensor. In another disclosed embodiment, one or more photo sensors are distributed across three sub-pixels. Accordingly, the aperture ratios of the sub-pixels may be substantially equal so that the light from each of the colors may mix in better or substantially equal amounts to generate white light.

In another embodiment, a white sub-pixel may be included with the sub-pixels of a pixel. A photo sensor may be integrated into the white sub-pixel. In this manner, the three colors of the light of the sub-pixels can be combined to form white light that can be further brightened by the white light behind the photo sensor of the white sub-pixel.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims. It is understood that the use of relational terms, if any, such as first and second, up and down, and the like are used solely to distinguish one from another entity or action without necessarily requiring or implying any actual such relationship or order between such entities or actions.

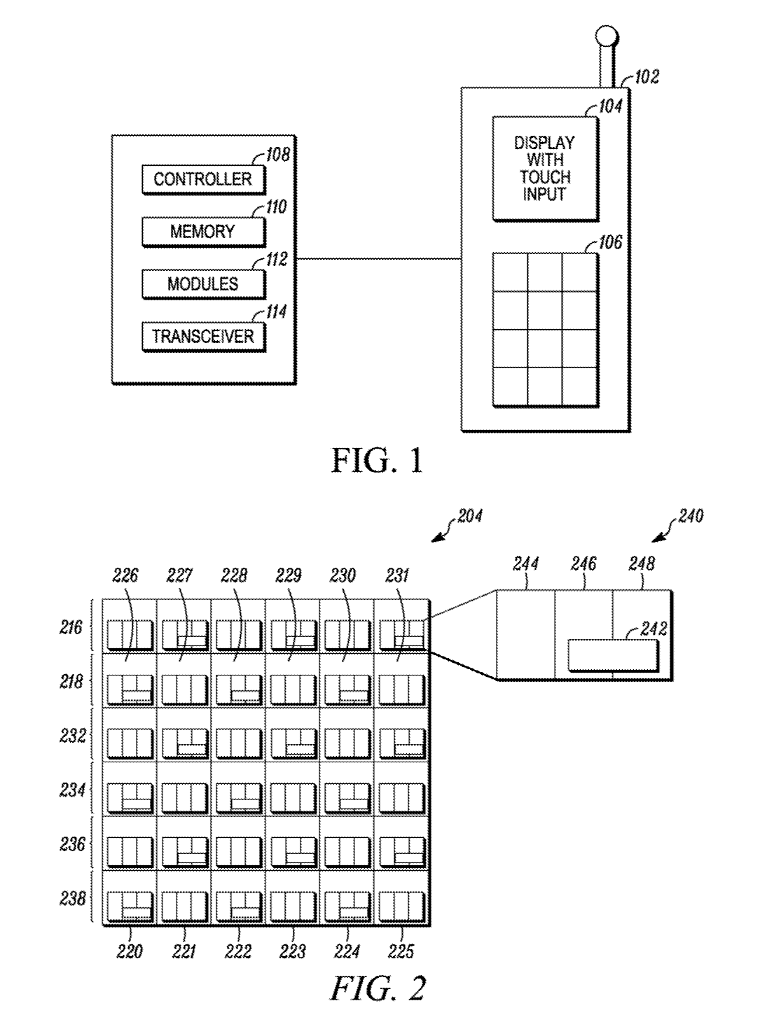

FIG. 1 depicts an electronic device 102, for example a mobile communication device. An electronic device can be any kind of device with a display. The depicted mobile communication device 102 can include a user interface including a display screen 104 and/or a keypad 106. The device 102 can further include a controller 108, a memory 110 and modules 112. If the electronic device 102 is a mobile communication device, it can include a transceiver 114. The modules 112 can provide instructions to the controller 108 to carry out certain processes of the methods as described herein. The modules 112 can be implemented in software, such as in the form of one or more sets of prestored instructions, and/or hardware, which can facilitate the operation of the mobile station or electronic device as discussed below. The modules 112 may be installed at the factory or can be installed after distribution by, for example, a downloading operation.

The electronic device 102 can be any type of wired or wireless device that includes a display screen 104. An electronic device that is a mobile communication device may be implemented as a cellular telephone (also called a mobile phone). The mobile communication device represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

A user interface such as the display screen 104 that is an input device can be coupled to the controller 108. The display screen 104 may have a surface where in FIG. 1 the term “display with touch input” appears. The user interface can include an array of pixels, such as those forming an RGB display, at least some of the pixels including photo sensors.

FIG. 2 depicts a display screen 204 that can include of an array of pixels. For example rows 216 and 218 include pixels 220, 221, 222, 223, 224, 225, 226, 227, 228, 229, 230 and 231. Additional rows of pixels 232, 234, 236 and 238 are also shown. At least a plurality of pixels, 221, 223, 225, 226, 228 and 230 are shown to include photo sensors. In this example, one out of two pixels includes photo sensors so that half the pixels include photo sensors. It is understood that any ratio of pixels with and without photo sensors is considered in this discussion.

FIG. 2 further illustrates an enlargement 240 of one pixel 225 including a photo sensor 242 and a plurality of sub-pixels 244, 246 and 248. The photo sensor 242 of the pixel 240 can be integrated into at least two of the sub-pixels 246 and 248 of the pixel 240. Input to the photo sensor 242 may be received by changes in the light received by the photo sensor 242. The controller 108 (see FIG. 1) can be configured to receive output from the photo sensor 242 of the pixel 240.

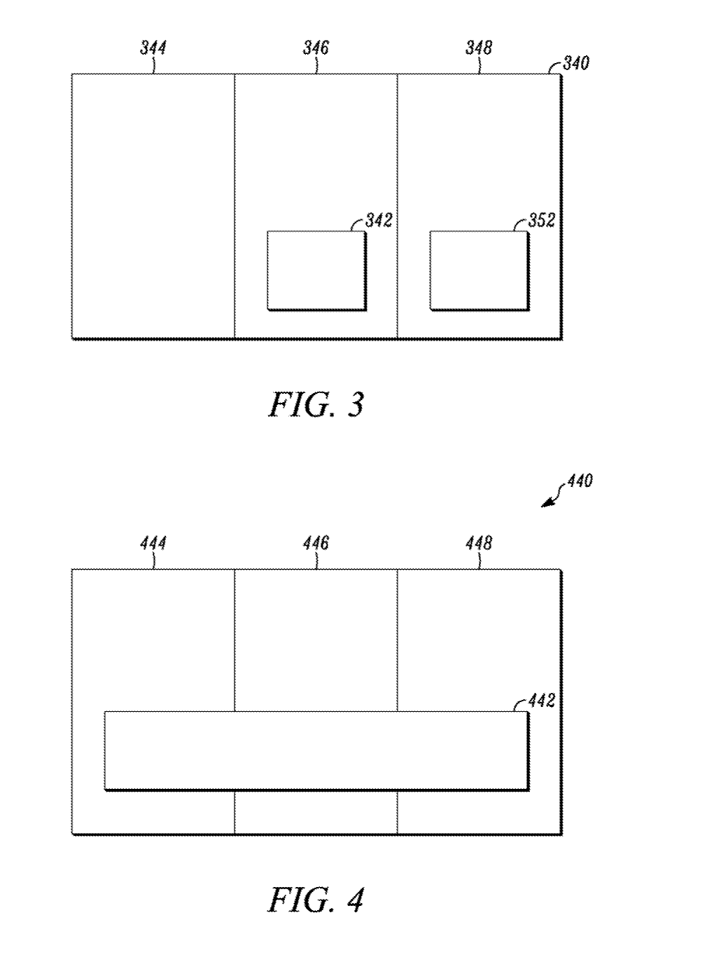

FIG. 3 illustrates another embodiment 340 similar to the enlargement 240 (see FIG. 2) of one pixel 225 where instead of one photo sensor 242, there may be two individual photo sensors 342 and 352. It is understood that when a pixel includes more than one individual photo sensor the photo sensors of the pixel may be defined as photo sub-sensors. That is, two sub-pixels 346 and 348 can have separate photo sensors 342 and 352 respectively. In either case, the embodiments shown in FIG. 2 and FIG. 3, one or more photo sensors 242 or 342 and 352 are distributed across two colored sub-pixels 246 and 248 or 346 and 348. Accordingly, the aperture ratios of the three sub-pixels of each embodiment of FIGS. 2 and 3 can be more substantially equal than the aperture ratios of the sub-pixels when a single sub-pixel of the pixel includes a photo sensor.

FIG. 4 depicts another embodiment 440 of a pixel including three sub-pixels 444, 446 and 448. One or more photo sensors 442 are integrated across three sub-pixels 444, 446 and 448. Accordingly, the aperture ratios of the sub-pixels 444, 446 and 448 may be substantially equal so that the light from each of the colors may mix in substantially equal amounts to generate white light.

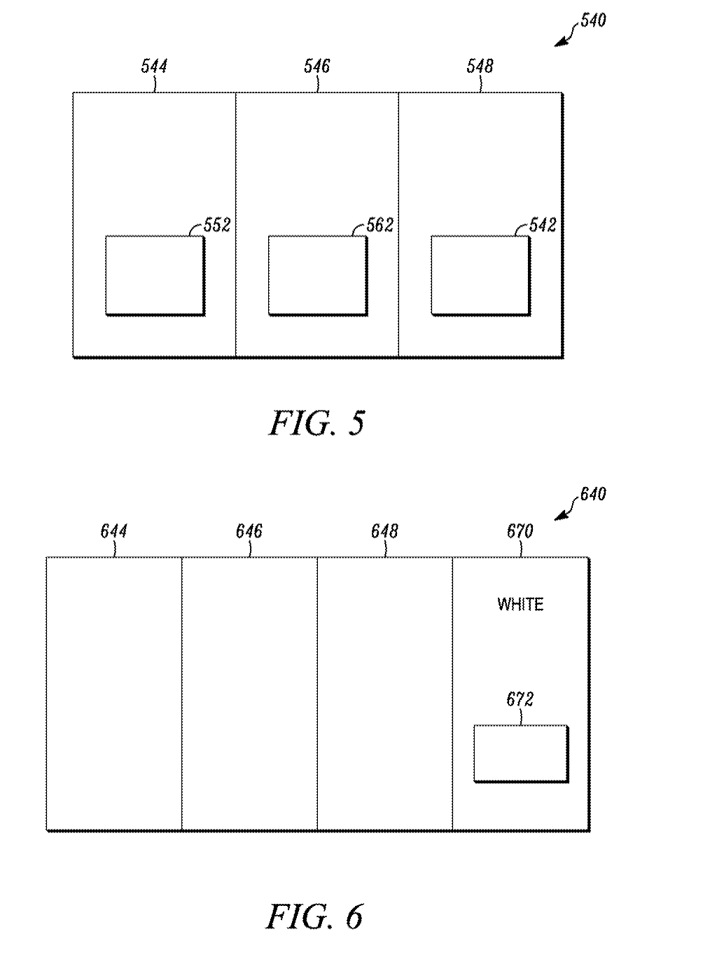

FIG. 5 depicts another embodiment 540 similar to that of FIG. 4. Three sub-pixels 544, 546 and 548 can include three individual integrated photo sensors 542, 552 and 562. As mentioned above in connection with FIG. 3, it is understood that when a pixel includes more than one individual photo sensor the photo sensors of the pixel may be defined as photo sub-sensors. Of course, a configuration of the photo sensor 242 (see FIG. 2) and individual photo sensor 552 may be combined so that three sub-pixels 544, 546, and 548 include integrated photo sensors. It is understood that any arrangement of photo sensors is possible. That is, photo sensors may be placed in any suitable position with respect to the pixel. Moreover, a photo sensor may have any suitable particular shape. Furthermore, the functionality of the photo sensors may be combined in any manner. Accordingly, the aperture ratios of the sub-pixels 544, 546 and 548 may be substantially equal so that the light from each of the colors may mix in substantially equal amounts to generate white light. Similarly in the case of two photo sensors incorporated with two sub-pixels as illustrated in FIGS. 2 and 3, the aperture ratios of those two sub-pixels are substantially equal.

FIG. 6 depicts a pixel 640 having at least one sub-pixel that is a white sub-pixel 670. A photo sensor 672 can be integrated into the white sub-pixel 670. In this manner, the colored light of the sub-pixels 644, 646 and 648 can be combined to form white light that is can be further brightened by the white light behind the photo sensor of the white sub-pixel 670. Of course, the sub-pixels 644, 646 and 648 may also include integrated photo sensors in any manner as described above.

The disclosed input devices, electronic devices and methods for integrating photo sensors into sub-pixels of pixels of an array of pixels may substantially maintain the brightness of a touch screen display. In one disclosed embodiment, one or more photo sensors are distributed across two colored sub-pixels. In another disclosed embodiment, one or more photo sensors are distributed across three sub-pixels. In yet another embodiment, a photo sensor may be integrated into a white sub-pixel. Accordingly, the aperture ratios of the sub-pixels may be substantially equal so that the light from each of the colors may mix in better or substantially equal amounts to generate white light.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. An input device incorporating pixels and photo sensors comprising:
an array of pixels including a plurality of pixels having a plurality of sub-pixels and a plurality of photo sensors integrated in at least two sub-pixels of the plurality of sub-pixels.

2. The input device of claim 1, wherein a photo sensor of the plurality of photo sensors is integrated in the at least two sub-pixels so that the at least two sub-pixels have substantially equal aperture ratios.

3. The input device of claim 1, wherein the plurality of sub-pixels comprises three sub-pixels, and wherein a photo sensor of the plurality of photo sensors is integrated in the three sub-pixels.

4. The input device of claim 3, wherein the photo sensor is integrated in the three sub-pixels so that the three sub-pixels have substantially equal aperture ratios.

5. The input device of claim 1, wherein one sub-pixel of the plurality of sub-pixels is a white sub-pixel.

6. The input device of claim 1, wherein:
a photo sensor of the plurality of photo sensors comprises a plurality of photo sub-sensors; and
a photo sub-sensor of the plurality of photo sub-sensors is integrated in each of the at least two sub-pixels.

7. The input device of claim 6, wherein the photo sub-sensor is integrated in each of the at least two sub-pixels so that the at least two sub-pixels have substantially equal aperture ratios.

8. The input device of claim 6, wherein the photo sub-sensor of the plurality of sub-sensors is integrated in each of three sub-pixels.

9. The input device of claim 6, wherein the photo sub-sensor of the plurality of sub-sensors is integrated in each of the three sub-pixels so that the three sub-pixels have substantially equal aperture ratios.

10. An input device incorporating pixels and photo sensors comprising:
at least one pixel having at least two sub-pixels, a sub-pixel of the at least two sub-pixels comprising a white sub-pixel; and
a photo sensor integrated in the white sub-pixel.

11. The input device of claim 10, wherein the at least one pixel comprises at least three sub-pixels.

12. An electronic device, comprising:
a user interface having a surface, the user interface comprising a plurality of pixels having a photo sensor and a plurality of sub-pixels, the photo sensor being associated with a pixel of the plurality of pixels and integrated in at least two sub-pixels of the plurality of sub-pixels associated with the pixel; and
a controller coupled to the user interface, wherein the controller is configured to receive output from the photo sensor of the plurality of pixels.

13. The device of claim 12, wherein the photo sensor of a pixel is integrated in the at least two of the sub-pixels of the pixel so that the at least two sub-pixels have substantially equal aperture ratios.

14. The device of claim 12, wherein the plurality of sub-pixels comprises three sub-pixels, and wherein the photo sensor is integrated in the three sub-pixels.

15. The device of claim 14, wherein the photo sensor is integrated in the three sub-pixels so that the three sub-pixels have substantially equal aperture ratios.

16. The device of claim 12, wherein each of the plurality of pixels includes a white sub-pixel.

17. The device of claim 12, wherein:
the photo sensor comprises a plurality of photo sub-sensors; and
a photo sub-sensor of the plurality of sub-sensors is integrated in each of the at least two sub-pixels associated with the pixel.

18. The device of claim 17, wherein the photo sub-sensor is integrated in each of the at least two sub-pixels associated with the pixel so that the at least two sub-pixels have substantially equal aperture ratios.

19. The device of claim 17, wherein the plurality of sub-pixels comprises three sub-pixels, and wherein a photo sub-sensor is integrated in each of the three sub-pixels.

20. The device of claim 19, wherein the photo sub-sensor is integrated in each of the three sub-pixels so that the three sub-pixels have substantially equal aperture ratios.
